(19) United States
(12) Patent Application Publication
(10) Pub. No.: US 2008/0155817 A1
(43) Pub. Date: Jul. 3, 2008

(54) Electric Reciprocating Cutting Tool

(76) Inventors: Trevor Stanley Lock, Victoria (AU); David John Greenfield, Victoria (AU)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/665,646

(22) PCT Filed: Oct. 18, 2005
(86) PCT No.: PCT/AU05/01609

§ 371 Date: Jan. 4, 2008

(30) Foreign Application Priority Data
Oct. 21, 2004 (AU) 2004906104

(51) Int. Cl. F16H 21/00; B23P 19/00

(52) U.S. Cl. 29/798; 74/25

(57) ABSTRACT

The specification discloses a machine device (10) driven by an inline electric motor (15) to reciprocate a cutting blade (12) when removal of a glass or similar panel is required from a surrounding mount structure, the machine device (10) includes an actuating mechanism having a first input shaft (22) rotatably driven about an input axis (23) by the electric motor (15), a second output member (24) including a connection (42) for a cutting blade (12) restrained for reciprocation along a second output axis (25), a first swivel connection (32) eccentrically disposed laterally from the input axis (23), a second swivel connection (31) having its swivel or pivot point on said second output axis (25), and a connector (26) connecting the first and second swivel connections (32, 31).

The present invention relates to improvements to apparatus for driving a cutting blade in a reciprocating manner for cutting a bonding strip between a glass or similar panel (typically a windscreen) and its surround, when the panel is to be removed.

Devices of the aforementioned kind are usually pneumatically driven simply because most machine or repair establishments have a ready source of compressed air and pneumatically operated tools are well adapted to providing a reciprocating output motion for a cutting blade or the like. In a number of applications or situations it is desirable to provide a much more portable tool that can be used outside of a repair or machine shop if desired but still perform as well as a conventional pneumatically operated tool. Pneumatically operated tools can be made portable by providing a portable compressed air supply, however, this is a bulky and cumbersome solution to the problem. It is of course known that electrically operated tools can be made highly portable by powering same with a rechargeable battery arrangement, however, in the above discussed application, the tool must also be relatively small and light such that it can be manoeuvred in the relatively close confines of a vehicle cabin or similar.

Accordingly, the present invention has for its objective the provision of a drive arrangement usable in a portable tool capable of converting rotary motion of an electric motor into a reciprocating motion for a cutting blade while preferably maintaining a relatively small, lightweight and manoeuvrable structure for the tool. The invention has particular preferred application in the field of removing panels from vehicles or other comparable applications where a single cutting blade is used to sever a bonding strip existing between the panel and a second structural or other member. Conveniently the panels are vehicle glass panels, but other applications are possible.

In accordance with a first aspect of the present invention, there is provided a drive arrangement for converting rotary drive motion into reciprocating motion, said drive arrangement including a first member mounted for rotation about a first axis, a second member axially spaced from said first member mounted for reciprocation along a second axis disposed coincident with or parallel to said first axis, a connecting member connected to said first member by first swivel connection means and to said second member by second swivel connection means whereby upon rotation of said first member about said first axis a line connecting said first and said second swivel connection means cycles between a position being in line with said second axis and at least one position forming an acute angle with said second axis.

According to a further aspect of this invention, there is provided a drive arrangement for converting rotary drive motion into reciprocating motion, said drive arrangement including a first member mounted for rotation about a first axis, a second member axially spaced from said first member mounted for reciprocation along a second axis, a connecting member connected to said first member by first swivel connection means and to said second member by second swivel connection means, the first swivel connection means being disposed laterally spaced from said first axis.

Preferred features of this invention may be as defined in claims 3 to 25 inclusive annexed hereto, the subject matter of these claims being incorporated into the disclosure of this specification by this reference thereto.

In a still further aspect, the present invention may provide a panel removal tool for removing panels from vehicles including a drive arrangement as described above, the tool further including an electrically driven drive motor having a rotatable output member rotatable about said first axis, and means for releasably mounting a cutting blade thereto for reciprocation along said second axis.

The drive arrangement according to this invention enables a reciprocating motion to be created from a rotary output drive shaft of a small axially in line electric motor. The reciprocating motion thus created is achieved in a simple and effective manner without creating a heavy or bulky machine. Conveniently the electric motor may be driven by a rechargeable battery or by a vehicle provided power source. In the case of a rechargeable battery, the battery is preferably disposed separate from the motor in use. The overall machine can be relatively compact and manoeuvrable making it suitable for use in confined spaces for cutting the securing adhesive bond of windscreens and similar panels (glass or otherwise) in vehicle applications including automobiles.

In the following, preferred embodiments of the present invention are described with reference to the annexed drawings having particular regard to removing vehicle windscreens or other similar glass panels from vehicle structures. It will of course be appreciated that other panels bonded in a structure might equally be removed by use of the described tool arrangement. In the accompanying drawings:

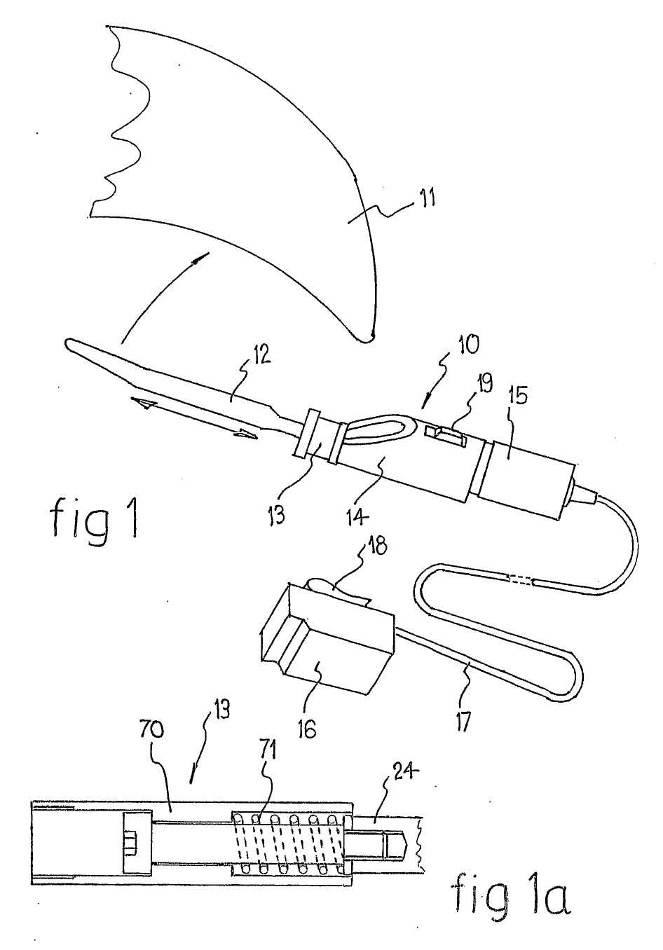

FIG. 1 is a general schematic layout drawing showing a preferred embodiment of a tool configuration;

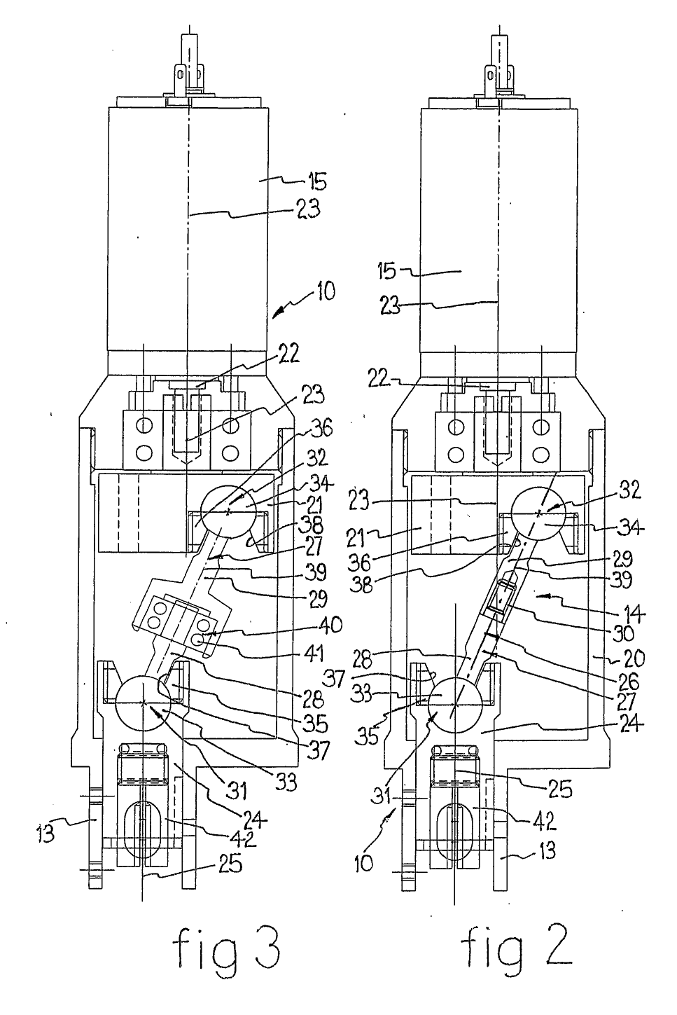

FIG. 2 is a cross-sectional view of a first preferred embodiment of the tool according to the present invention;

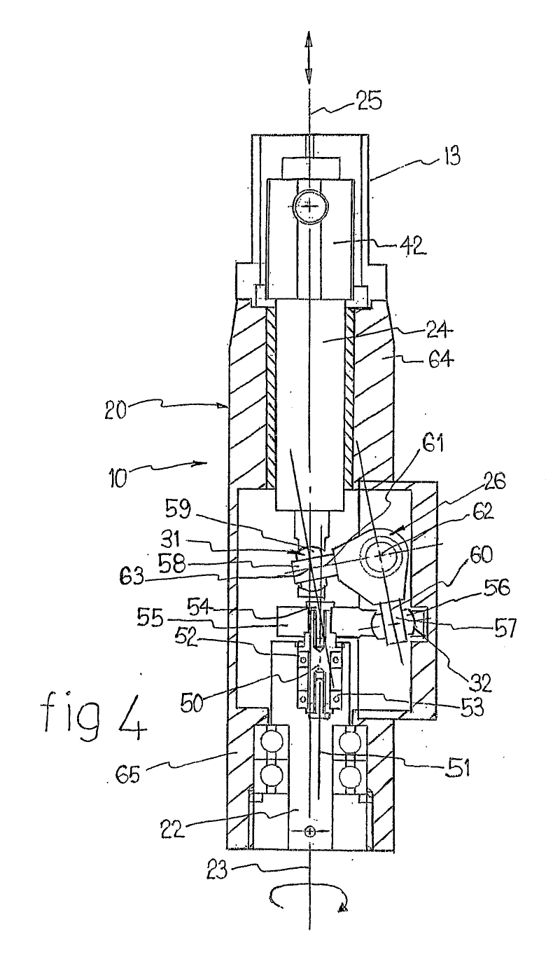

FIG. 3 is a view similar to FIG. 2 showing a second preferred embodiment;

FIG. 4 is a cross-sectional view of a further preferred embodiment of the tool according to the present invention; and

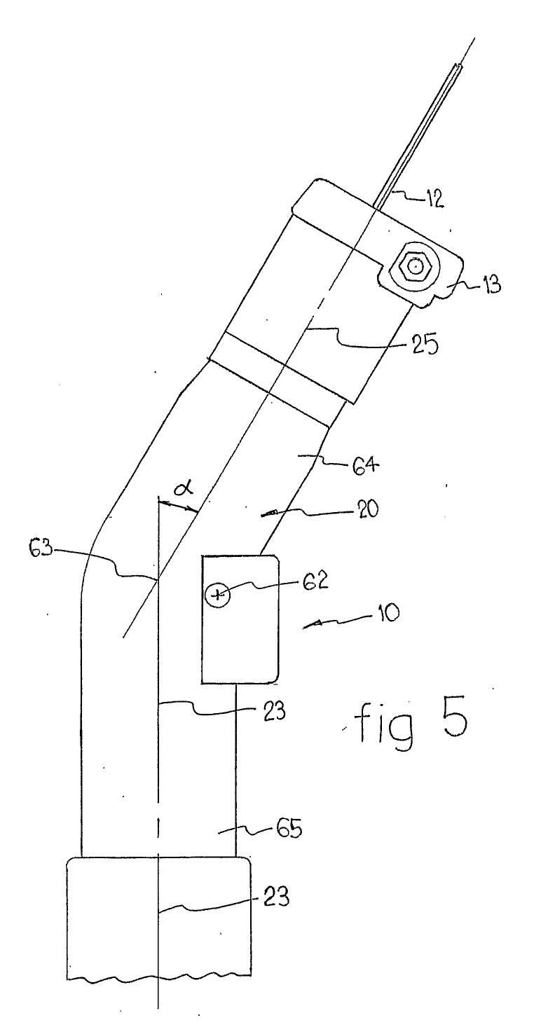

FIG. 5 is an illustration of a further modification of the tool shown in FIG. 4.

Referring first to FIG. 1, a tool 10 is shown schematically for cutting the bonding strip or similar securing a windscreen 11 into a surround in a vehicle. The tool 10 includes a reciprocal cutting blade 12 releasably secured to a chuck or similar device 13 carried by an actuating mechanism 14 driven by a rotary electric drive motor 15. The device 13 may be adapted to not only locate and guide the blade 12 but may also adjustably hold a depth gauge bar member either above or below the blade 12 to control the penetration length of the blade beyond the end of the bar member. In addition to selectably positioning such a depth gauge bar member above or below the cutting blade 12, it is also desirable to be able to rotate the device 13 between a plurality of releasable stop positions through 360° to reorientate the blade and the depth gauge member as may be desired. Power may be supplied to the drive motor 15 from a rechargeable battery 16 via a flexible lead 17. The battery 16 may include a clip 18 or similar allowing it to be carried readily on the belt (or some other part) of a user's clothing. Alternatively, the battery 16 may simply be left free. In a possible alternative, the lead 17 might have a connection means enabling connection to a vehicle power take off point (eg cigarette lighter or similar). The power take off point might be in a vehicle being worked upon or it might be in a separate vehicle such as the operator's vehicle. A switch 19 enables power to be supplied to the motor 15 or disconnected therefrom whereby the cutting blade 12 is reciprocated or kept stationary when not in use. When in use, it is desirable to reciprocate the cutting blade between 4000 and 4500 reciprocations per minute, conveniently at about 4200-4300 reciprocations per minute. It might also be desirable to provide an adjustable controller to enable selective reduction of the normal blade speed for particular applications. It will of course be recognized that the battery 16 might be releasably mounted directly to the electric drive motor 15, however, this will increase the weight, size and bulk of the tool and is not entirely desirable given the vibrations that do occur in use and the confined space in which the tool 10 is often used.

As is described hereafter with reference to FIGS. 2 to 4, mechanical actuating mechanisms 14 for converting the rotary motion supplied by the electric motor 15 to reciprocating motion, provides little axial give or axial resilience to the cutting blade 12 should it hit a rigid object in use as is the case with some pneumatically driven tools. This can cause damage to the rigid structures hit and/or the cutting blade 12. To some extent the problem is mitigated by using a depth gauge bar member as discussed above, however, it is still desirable to give to the tool 10, a feel in operation similar to that of a pneumatically driven tool of a similar type. FIG. 1a illustrates one preferred method of achieving this. In this embodiment the chuck 13 is formed with an outer axially slidable sleeve 70 to which the cutting blade 12 is connected by any suitable means. The member 24 is, in use, reciprocated axially via the actuating mechanism 14 and a spring 71 is interposed between the member 24 and the outer chuck sleeve 70. In normal operation, the spring 71 has a rating such that it does not substantially compress, however, should the cutting blade hit a rigid element, the spring 71 can compress to minimize damage to the rigid element hit or the cutting blade 12.

FIGS. 2 and 3 illustrate a tool 10 including actuating mechanisms 14 of two different preferred embodiments, each being connected to the output shaft of a speed reduction gear arrangement driven by the electric drive motor 15. Certain parts including electrical connections have been omitted from FIGS. 2 and 3 for the sake of clarity. In FIG. 2, the actuating mechanism 14 is mounted within an outer support housing 20 and includes a first member 21 rotatably driven by the output drive shaft 22 of the drive motor 15 for rotation about a first axis 23. The first member 21 does not move axially and rotates only when drive power is supplied to the motor 15. The support housing 20 supports a second member 24 with the mounting arrangements of the second member 24 relative to the housing 20 being such as to ensure the second member 24 can reciprocate along a second axis 25 but cannot rotate about the second axis 25. The second axis 25 is laterally displaced relative to the first axis 23 but is parallel thereto.

A connecting member 26 generally connects the first member 21 to the second member 24 via first and second swivel connectors 32, 31 as described hereafter. The connecting member 26 includes a shaft 27 made in two parts 28, 29 with a threaded connection 30 intermediate the ends of the member 26. The threaded connection 30 enables the length of the member 26 to be adjusted as may be desirable. Opposite ends of the parts 28, 29 include ball joints forming the swivel connectors 32, 31 each of the swivel connectors 32, 31 including a ball part 33, 34 constrained within a ball retaining cavity by a retaining nut 35, 36. The retaining nuts 35, 36 have frusto-conical recesses 37, 38 accommodating cyclic movement of the connecting member 26. It will be apparent from FIG. 2 that with the line 39 joining the swivel connectors 31, 32 making a maximum acute angle (as illustrated) with the second axis 25, the second member 24 is withdrawn to a maximum extent within the housing 20. As the first member 21 rotates about the first axis. 23 from the illustrated position, the acute angle becomes progressively smaller until line 39 is directly in line with the second axis 25. In this position the second member 24 is extended to its maximum distance in an outwards direction relative to the housing 20. Further rotation of the first member 21 causes the second member to be progressively withdrawn towards the illustrated position in FIG. 2. Continued rotation of the first member 21 driven by the motor 15 repeats the cyclic reciprocation of the second member 24. A cutting blade 12 may be connected for reciprocation with the second member 24 by a suitable attachment means 42 when the tool 10 is in use.

FIG. 3 illustrates a second preferred embodiment where like features in the embodiment of FIG. 2 have been identified by the same reference numerals. In FIG. 3, the main difference is the provision of a third swivel connection 40 between the connecting shaft parts 28, 29 whereby the shaft parts 28, 29 can relatively rotate about the axis defined by line 39. The swivel connection 40 might be achieved by the use of ball, roller or needle bearings illustrated schematically at 41 between the shaft parts 28, 29. The provision of the swivel connection 40 between the shaft parts provides a smoother operation with less noise and less wear.

FIG. 4 illustrates yet another preferred embodiment of a tool 10 similar to FIGS. 2 and 3 where like features have again been given similar reference numbers to the earlier drawings. In this embodiment a shaft member 50 is provided with an axis 51 disposed parallel to the rotational axis 23 of the drive shaft 22 but spaced eccentrically therefrom. The shaft member 50 is carried by the drive shaft 22 via bearings 52, 53. The outer end 54 of the shaft member 50 has a transversely extending member 55 connected thereto with the first swivel connector 32 being disposed at a transversely spaced end region of the member 55. In this case, the swivel connector 32 is formed by a first bearing assembly 56 having outer part cylindrical swivel surfaces cooperating with similar formed surfaces on the member 55. The inner region of the first bearing assembly 56 carries a shaft part 57 forming part of the connecting member 26. The correcting member 26 has a second shaft part 58 generally disposed laterally extending (perpendicular) to the shaft part 57 with the shaft part 58 being supported by a second bearing assembly 59 forming the second swivel connector 31. The bearing assemblies 56, 59 are similarly constructed. The axes 60, 61 of the shaft parts 57, 58 intersect at a pivot axis 62 such that the connecting member 26 rocks about this pivot axis 62. The second bearing assembly 59 is carried by the second member 24 at an inner end thereof with the outer part cylindrical swivel surfaces of the bearing assembly 59 cooperating with complementary shaped surfaces formed on the member 24.

In operation, the input shaft 22 may be rotated about axis 23 by an electrically driven motor as described with previous embodiments. Rotation of the input shaft 22 causes the transversely extending member 55 to cyclically move between left and right positions which in turn cause the connecting member 26 to rock about its pivot axis 62. This motion causes the output reciprocable drive member 24 to reciprocate along axis 25 thereby causing any cutting blade connected at 42 to member 24 to also reciprocate along the axis 25. In the illustrated embodiment, the axes 23 and 25 are shown to be coincident but the axis 25 might be laterally spaced from the axis 23 by altering the dimensions and/or the positioning of the connecting member 26 and its pivot axis 62. Altering the disposition of the shaft points 57, 58 could also permit changing the angle of the axis 25 relative to the axis 23. Moreover, the output reciprocating axis 25 might be arranged at an angle a to the axis 23 so long as the axis 25 passes through the swivel (pivot) point 63 of the second swivel connector 31. The angle a might conveniently vary from 0° where the axes 23/25 are coincident; up to 90° where the axes 23/25 are perpendicular to one another. Such a structure is illustrated in FIG. 5 where a housing part 64 adjacent the cutting blade 12 in use is disposed at an angle to the remainder 65 of the housing 20 carrying the electric motor (not shown).

Many variations or modifications to the disclosed arrangements will be apparent to those skilled in this art within the scope of the invention defined in the annexed claims.

1. A drive arrangement for converting rotary drive motion into reciprocating motion, said drive arrangement including a first member mounted for rotation about a first axis, a second member axially spaced from said first member mounted for reciprocation along a second axis disposed coincident with or parallel to said first axis, a connecting member connected to said first member by first swivel connection means and to said second member by second swivel connection means whereby upon rotation of said first member about said first axis a line connecting said first and said second swivel connection means cycles between a position being in line with said second axis and at least one position forming an acute angle with said second axis.

2. A drive arrangement for converting rotary drive motion into reciprocating motion, said drive arrangement including a first member mounted for rotation about a first axis, a second member axially spaced from said first member mounted for reciprocation along a second axis, a connecting member connected to said first member by first swivel connection means and to said second member by second swivel connection means, the first swivel connection means being disposed laterally spaced from said first axis.

3. A drive arrangement according to claim 2 wherein said second swivel connection means is located on said second axis.

4. A drive arrangement according to claim 2 wherein said second swivel connection means is located spaced laterally from said second axis.

5. A drive arrangement according to claim 1 wherein said second member is restrained to not rotate about said second axis.

6. A drive arrangement according to claim 1 wherein said second member includes means for releasably mounting a cutting blade thereto.

7. A drive arrangement according to claim 1 wherein said first axis is laterally spaced from said second axis.

8. A drive arrangement according to claim 1 wherein the connecting member is adjustable in length.

9. A drive arrangement according to claim 1 wherein the connecting member includes at least two parts with a third swivel connection means located between said two parts whereby each said connecting member part can swivel relative to the other said connecting member part about an axis joining said first and said second swivel connection means.

10. A drive arrangement according to claim 2 wherein said second axis is disposed coincident with or parallel to said first axis.

11. A drive arrangement according to claim 2 wherein said second axis defines an angle with said first axis and intersects said first axis at a pivot centre of said second swivel connection means, said angle being between 0° where said first and said second axes are coincident with one another and 90°.

12. A drive arrangement according to claim 11 wherein said angle is an acute angle.

13. A drive arrangement according to claim 2, wherein said connecting member is a rocker having a fixed pivot axis laterally disposed relative to the second swivel connection means.

14. A drive arrangement according to claim 13 wherein the rocker has stub axle parts having axes intersecting the fixed pivot axis of the rocker.

15. A driven arrangement according to claim 2, wherein an eccentrically disposed shaft part is provided with an axis spaced laterally from and parallel to said first axis, said shaft part being connected to said first swivel connection means by a laterally extending link member.

16. A drive arrangement according to claim 1 further including a drive means having a speed reduction gearing arrangement driven by an electrically operated drive motor, said drive means having an output drive axis coincident with or parallel to said first axis and drivingly connected to said first member.

17. A drive arrangement according to claim 16 further including speed control means for adjustably controlling speed of rotation of said first member.

18. A drive arrangement according to claim 16 further including an electric power supply provided by a rechargeable battery means adapted to supply power to said drive motor and switch means to activate the supply of power to said drive motor or to disconnect said drive motor from said power supply.

19. A drive arrangement according to claim 16 further including power connection means electrically connected to said electrically operated drive motor, said power connection means being configured to electrically connect with a power connection point for a power supply of a vehicle, and switch means to activate the supply of power to said drive motor or to disconnect said drive motor from said power supply.

20. A drive arrangement according to claim 18 wherein said first member, said second member and said connecting member are arranged in a support housing, said switch means being carried by said support housing.

21. A drive arrangement according to claim 18 when appended to claim 18 wherein said rechargeable battery means is remote from said drive motor and connected thereto by a power supply lead.

22. A drive arrangement according to claim 21 wherein said rechargeable battery means includes carry means adapted to support said battery means from an operator's clothing.

23. A drive arrangement according to claim 1 wherein the second member is reciprocable at a rate of between 4000 and 4500 reciprocations per minute.

24. A drive arrangement according to claim 6 when appended through claim 6 further including a chuck arrangement carried for reciprocation with said second member, said chuck arrangement including a first part configured to enable a said cutting blade to be releasably connected thereto.

25. A drive arrangement according to claim 24 further including compression spring means operable between said first part of said chuck arrangement and a second part of said chuck arrangement whereby said first part is relatively movable against an urging force supplied by said compression spring means should a said cutting blade connected to said first part strike an immovable object or structure during operation.

26. A panel removal tool for removing panels from vehicles including a drive arrangement according to claims 1, said tool further including an electrically driven drive motor having a rotatable output member rotatable about said first axis, and means for releasably mounting a cutting blade thereto for reciprocation along said second axis.
